(19) United States
(12) Patent Application Publication
(10) Pub. No.: US 2012/0324239 A1
(43) Pub. Date: Dec. 20, 2012

(54) METHOD AND DEVICE FOR OPERATING A VIRTUAL MACHINE IN ACCORDANCE WITH AN ASSOCIATED INFORMATION ON ASSIGNMENT OF RIGHTS

(75) Inventors: Rainer Falk, Erding (DE); Steffen Fries, Baldham (DE); Stefan Seltzsam, Ismaning (DE)

(73) Assignee: Siemens Aktiengesellschaft, Munich (DE)

(21) Appl. No.: 13/519,991

(22) PCT Filed: Nov. 24, 2010
(86) PCT No.: PCT/EP2010/068142

§ 371 Date: Jun. 29, 2012

(30) Foreign Application Priority Data
Dec. 29, 2009 (DE) 10 2009 060 686.6

(51) Int. Cl. G06F 21/00

(52) U.S. Cl. 713/189

(57) ABSTRACT

Virtual machines are used in the utilization of distributed computer infrastructures to be able to distribute the workload to individual computers in as flexible a manner as possible. For this purpose, it is necessary to restrict the use of the virtual machine in a robust manner by regulatory or administrative defaults. A method protects a virtual machine during the migration, storage or operation thereof by way of digital rights management and encryption. For this purpose, the hypervisor or the virtual machine monitor as well as the virtual machine are expanded by corresponding functionalities.

### CROSS REFERENCE TO RELATED APPLICATIONS

This application is based on and hereby claims priority to International Application No. PCT/EP2010/068142 filed on Nov. 24, 2010 and German Application No. 10 2009 060 686.6 filed on Dec. 29, 2009, the contents of which are hereby incorporated by reference.

### BACKGROUND

The present invention relates to a method and a device which allow rights for operating a virtual machine to be effectively enforced. In addition the present invention relates to a method for protecting a virtual machine from unauthorized operation.

Cloud Computing offers the opportunity of providing services based on new business models. In such cases cloud computing services can be provided at different levels:
Infrastructure: A potential customer leases pure processing power in order to implement their own services. For this purpose cloud computing uses computer centers which are either concentrated at one location or can also be connected together for the provision of flexible services.
Platform: The customer is given access to a platform which on the one hand contains the infrastructure for the provision of their service and on the other hand contains specific software (middleware) with the aid of which services can be created.
Software: A customer is given access to the complete application which is Web based and provides the desired service.

Common to all approaches is the requirement for the underlying infrastructure to be available on demand. The infrastructure provided should in such cases be able to be handled as flexibly as possible so that the processing power can be expanded very rapidly and the distribution of the services on the computers can be adapted dynamically. The technique of virtualization offers one option for doing this, with the aid of which completely independent so-called virtual machines can be executed by what is referred to as a hypervisor on one computer. Modern virtualization solutions can virtualize any given operating systems, runtime environments and applications with appropriate hardware support. A running virtual machine can be stored at any time in a so-called image and copied onto any other given computer with a hypervisor and execution can be continued there. This is referred to as “migration” of a virtual machine. One advantage of this technical process is that the load is better distributed between the servers, in that a plurality of virtual machines are executed on one server. A further advantage is that a flexible reaction to increased or reduced requirements of individual virtual machines is possible. Thus for example a virtual machine with an increased demand for resources can be transferred temporarily to a more powerful server and its execution can continue there.

The global distribution of infrastructure of a cloud computing supplier enables a virtual machine to be migrated worldwide. In such cases however the influence of regulatory requirements should be considered, for example that the hosting of specific technologies is forbidden in some countries. Another problem is that a user of a cloud computing infrastructure is located in a country which is under an embargo by other countries. In such a case the virtual machine of such a customer can only be executed in a few countries or only with specific restrictions.

In the migration of a virtual machine—either at runtime or also for storage on a hard disk for subsequent execution—the security of the data should also be guaranteed, in order to prevent unauthorized access to the virtual machines.

Other requirements can arise in respect of various customer wishes. A potential user of a cloud computing infrastructure might possibly want to restrict the circle of parties involved in service provision even further. Another customer of a cloud computing service for their part wants to ensure that specific virtual machines run on dedicated hosts of their cloud computing infrastructure.

### SUMMARY

One potential object is thus to specify a method for storage, migration and/or operation of virtual machine with which rights able to be specified by the rights owner can be enforced and unauthorized access prevented.

The inventors propose a method for protecting a virtual machine by a control entity in which the following are executed:
Creating a copy of virtual machine,
Encrypting the copy of the virtual machine with a secret key,
Providing at least one item of rights information comprising the private key and a usage authorization,
Assigning the rights information to the encrypted virtual machine,
   with the encrypted virtual machine and the assigned rights information being stored on demand, and the virtual machine being able to be decrypted and operated in accordance with the specifiable usage authorization.

An image (copy) of a virtual machine is protected from unauthorized access by the method, regardless of where and how it is stored or transmitted. In particular protection is also implemented against offline analysis of an image stored at an infrastructure operator, since the protected image is present in encrypted form.

The rights information can define access information or access rights in respect of at least one part of the virtual machine. For example it is possible for a specific processing unit, which for example is defined by an IP address and/or an IP area, to just obtain rights to individual parts of the virtual machine. These rights can for example also be a linkage of a virtual machine to dedicated computers in a cloud computing infrastructure. A specific virtual machine may in this case only be executed on specific, defined processes or only on processors which fulfill specific criteria (for example country, membership of a processor pool). These rights can however also relate to a processor which may only execute specific virtual machines. Thus a processor is restricted here to the virtual machine that it may execute or to the criteria that a virtual machine must fulfill so that it may execute the machine (for example only the virtual machines assigned to a specific user). The rights information describes which usage rights or usage restrictions a specific actor has on the virtual machine provided.

Usage restrictions regarding execution by a host for example relate to:
Export-controlled functionalities
Rights that the owner of the virtual machine has defined, such as country of execution, provider to whom the infrastructure belongs, company policy specifications etc. for example.
Restrictions of the execution environment by the cloud computing provider, for example for mandate separation.
Functionalities that are only granted to customers with a specific Service Level Agreement (premium customer)

The rights information can be provided together with the virtual machine and/or separately from the virtual machine.

It is also possible for the rights information to be provided by a first server and for the virtual machine to be provided by a second server.

If further units are necessary for execution of the virtual machine the rights information can also specify these further units.

The inventors also propose a method for operation of a virtual machine by a control entity in accordance with rights information, in which the following are executed:
Requesting at least one item of rights information which is assigned to the virtual machine,
Determining a usage authorization for operating the virtual machine from the at least one requested item of rights information, and
Determining a key from the at least one requested item of rights information for a determined usage authorization for operating the virtual machine,
Decrypting the virtual machine with the key determined and operating the decrypted virtual machine within the scope of the usage authorization determined.

A simulation, emulation, virtualization and/or at least a part thereof can be executed by the virtual machine. For example the virtual machine can be executed partly by emulation and partly by virtualization. In this case physical hardware units of the host system, also called the guest system, are mapped. For example the host system includes a physical hardware unit which acts in accordance with an exchangeable data medium as a read device. A physical hardware unit, for example a CD reader, can be simulated in the virtual machine in accordance with mapping. In this case the virtual machine provides at least a part of the functionality of the physical CD reader. The virtual machine can thus involve a plurality of control commands which provide a physical hardware unit or a plurality of physical hardware units which interact with each other. A virtual machine created in this way in accordance with at least one item of rights information consequently involves an image of the host system in accordance with a specification provided.

The mapping of the physical hardware unit is especially advantageous when the physical hardware unit is in operation and operation cannot be interrupted. If for example the physical hardware unit offers a service, it can be mapped and, using the mapped, virtual hardware unit, request parameters to the physical hardware unit can be specified. The service offered can thus be provided without interrupting the physical hardware unit. In particular it is possible to carry out the mapping of hardware units based on software. To this end operating parameter profiles can be varied systematically and reproducibly without modification of the physical processor unit.

The mapping can also instigate an emulation or virtualization. In this case emulation can comprise the partial provision of functionalities by the virtual hardware unit, with functionalities not provided by a physical hardware unit being able to be provided. Virtualization can in this case comprise the provision of functionality by the virtual hardware unit. The mapped hardware unit is present virtually and is described and/or mapped for example by a software component and/or by a library. The physical hardware unit is present physically, i.e. materially.

Emulation can comprise the partial provision of functionality by the virtual hardware unit, with functionality not provided able to be provided by a physical hardware unit. For example in an emulation read accesses to a first data record of a hard disk can be executed by a virtual hardware unit and write accesses to a second data record of the hard disk can be executed by a physical hardware unit.

Virtualization in this case can describe the complete provision of functionality by the virtual hardware unit. For example in a virtualization of a physical hard disk the functionality of the physical hard disk, such as the reading and writing of the data records for example, can be executed by a virtual hard disk. A virtual hard disk in this case is a virtual hardware unit which provides the functionality of a physical hard disk by emulation or virtualization. Operating parameters of the virtual hardware unit, such as the storage capacity for example, can in this case be provided using a physical hard disk.

A physical computer system is thus mapped as a virtual computer system, with the virtual computer system in its turn able to be formed of a plurality of virtual hardware units.

Access and usage rights to the virtual machine can thus be described by the rights information in a fine granular manner and in relation to a plurality of characteristics.

In a further embodiment of the method a policy is created for the virtual machine as a function of the rights information. This has the advantage of enabling already established methods for using the virtual machine to be able to continue to be used.

In a further embodiment of the method the virtual machine is configured, operated and/or executed as a function of the created policy. This has the advantage that the policy can be used both at runtime of operation of the virtual machine and also at the time that the virtual machine is created.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a block diagram of the first system architecture for the proposed method with a hypervisor for operating a virtual machine,

FIG. 2 shows a block diagram of a second system architecture for the proposed method with a Virtual Machine Monitor for operating a virtual machine.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

During virtualization a guest operating system is executed in a virtual machine. A virtual machine is a virtual computer which is executed as software. The virtual machine is executed however on a host, i.e. a physically existing computer. A plurality of virtual machines can be operated simultaneously on one physical computer.

A hypervisor or Virtual Machine Monitor (VMM) is virtualization software which creates an environment for virtual machines. The virtualization software can be divided into a Type 1 and a Type 2. Type 1 runs without further software directly on the hardware. Type 2 is based on a fully-fledged operating system.

With Type 1 the platform provides a virtualization solution as a separate layer or as a host operating system. Guest systems run in their own containers. A Type-1 hypervisor as a rule uses fewer resources but must itself have drivers available for all hardware.

With Type 2 virtualization software runs on a standard operating system, in which guest operating systems can run in their turn. In parallel native applications can also run on the host. A Type-2 hypervisor uses the device drivers of the operating system under which it runs.

Virtual machine migration makes it possible to move a virtual machine from one physical host to another. In such cases an image of a virtual machine is essentially sent from one host to another. This migration can also take place during ongoing operation.

One aspect is to implement the protection of a virtual machine during its migration or during its storage in an image by digital rights management. For this purpose the Hypervisor or the Virtual Machine Monitor as well as the virtual machine is expanded by corresponding functionalities.

One example of rights management is for example Enterprise Rights Management (ERM). This for example realizes access protection to documents irrespective of where the documents are stored. A protected document can be opened and processed only by an authorized user in accordance with their access rights applicable for the document, regardless of the storage device on which the document has been stored or the processing unit to which the document was sent. An unauthorized third-party to whom no access rights have been granted cannot obtain any information with a copy of the document which was sent electronically for example.

In conventional methods documents are encrypted in accordance with at least one encryption algorithm. The publisher of the document encrypts a document before releasing it and additionally defines the rights of specific users or groups to the content of the document in rights information. The encrypted file can be sent along with the rights information to an ERM server. In addition the rights information can have a key which is used to encrypt the document. Since it is precisely this key that represents secret information, the rights information can be encrypted with the public key of the ERM server and the publisher can digitally sign the rights information.

In addition to the ERM server, which represents a central part of rights management, there is an ERM client which is installed on each accessing machine that wishes to read out access-protected documents. The ERM client can in this case handle communication with the ERM server in order to determine the key and the rights of a document that is present. The ERM client can forward the rights read to a further read-out unit which is provided for maintaining the rights. The ERM client, which also carries out any renewed encryption which may be required at a later time, can handle decryption of the document. The key can be kept secret from further readout units by the ERM client by an encryption technique. Encryption techniques or concealment techniques such as code obfuscation are used in conventional methods.

The inventors propose for the hypervisor or the Virtual Machine Monitor to now include a client as additional functionality that is able to request the rights information which is assigned to the image of the virtual machine from a server and evaluate it. It can also, before the migration or storage of the virtual machine for example, define the authorizations assigned to it. Furthermore it can generate corresponding rights information and store it on a server. In this way the image of the virtual machine is protected, in order to restrict the permitted execution environment of the virtual machine accordingly depending on the specified rights.

These restrictions can be a linkage of a virtual machine to a dedicated computer in a cloud computing infrastructure. A specific virtual machine may in such cases only be executed on specific, defined computers or only on computers which fulfill specific criteria (for example country, membership of a computer pool). These restrictions can however also relate to a computer which may only execute specific virtual machines. A computer is thus subject to a restriction here as to which specific virtual machine it may execute or as to the criteria that a virtual machine must fulfill so that it may execute on the computer (for example only the virtual machines assigned to a specific user).

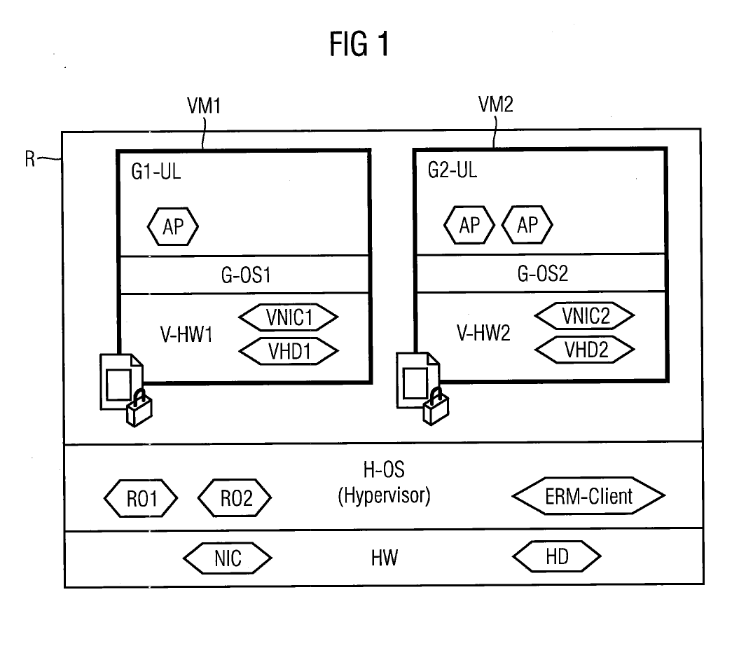

FIG. 1 shows the schematic of a first computer system R, which in one embodiment of the method can be used for protection and/or for operation of a virtual machine as host system for a virtualization. The host system has a plurality of hardware components HW, for example the network interface card NIC and the hard disk HD. A host operating system H-OS, which is embodied as a Hypervisor of Type 1 is used on the host processor R. The Hypervisor comprises an ERM client and manages two rights objects R01 and R02, which respectively define the usage rights for the execution of one virtual machine. These rights objects are linked directly to the respective virtual machine.

Two ERM-protected virtual machines VM1 and VM2 run on the host operating system H-OS. The Hypervisor provides virtual hardware V-HW1, V-HW2 in each case, with a virtual network interface card VNIC1, VNIC2 and virtual hard disk VHD1, VHD2. A guest operating system G-OS1 and G-OS2 runs in each virtual machine. In addition application programs AP run in user mode G1-UL, G2-UL of the respective virtual machine.

The computer is connected to a network by the network adapter card NIC, via which for example an ERM server is able to be contacted.

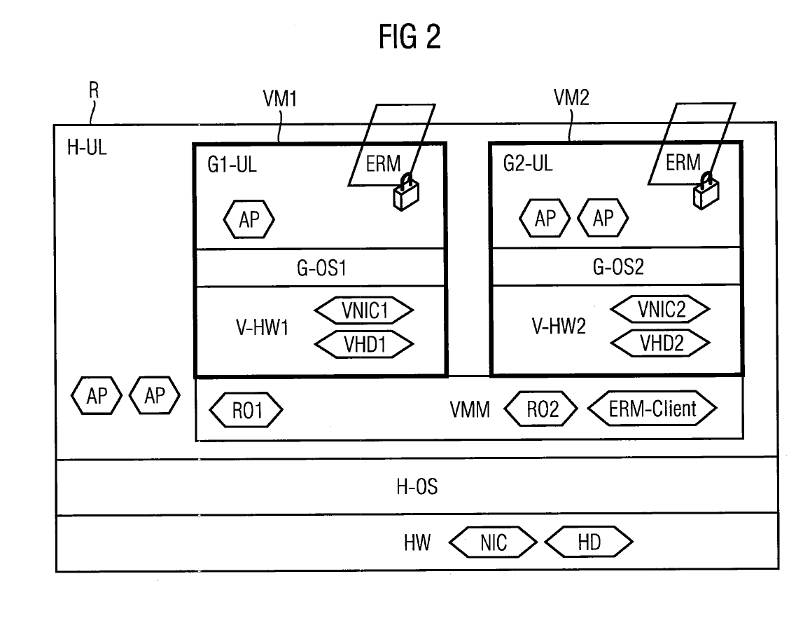

FIG. 2 shows a second computer system R which can be used in one embodiment of the method for protecting and/or operating a virtual machine as host system for a virtualization. The host system has a plurality of hardware components HW, for example the network adapter NIC and the hard disk HD. A host operating system H-OS is used on the host processor R. In this case a user mode H-UL, also referred to as user land, can be provided, in which application programs AP are executed. In the present FIG. 2 a plurality of application programs are used, which are labeled AP in each case. As a result the application programs AP can each involve different application programs AP.

Furthermore a Virtual Machine Monitor VMM of Type 2, which provides a virtual operating environment, is executed on the host processor. The Virtual Machine Monitor VMM comprises an ERM client and manages two rights objects R01 and R02, which each define the usage rights for the execution of a virtual machine. These rights objects R01, R02 are linked directly to the respective virtual machine.

In addition two ERM-protected virtual machines VM1 and VM2 are executed. The Virtual Machine Monitor VMM provides virtual hardware V-HW1, VHW2 with a virtual network interface card VNIC1, VNIC2 and a virtual hard disk VHD1, VHD2 in each case. A guest operating system G-0S1, G-0S2 is operated in the virtual machine VM in each case. A plurality of application programs AP are executed in the user land G1-UL, G2-UL of the respective virtual machine.

In addition the processor R is linked by the network interface card NIC to a network such that a rights server can be accessed.

In one embodiment of the method for operating the virtual machinehe present invention, on the first or second computer system R, before a virtual machine is started on the respective computer system, the usage conditions of a VM image are checked in each case by the ERM client of the hypervisor. Depending on the results the execution of the VM is granted or denied.

To this end the following steps are executed by a Hypervisor, which includes the functionality of an ERM client for this purpose:
Receiving of a signal for starting up a specific VM
Loading the ERM-protected VM images of the VM to be started up
Authentication in respect of a rights server (ERM server)
Requesting the rights information assigned to the VM to be started up from the rights server (ERM server)
Defining the authorization for starting the VM
If the result is negative: Aborting (execution of the VM is denied)
If the result is positive: determining a key from the rights information; cancelling the ERM protection of the ERM-protected VM image (i.e. decrypting the VM image with the aid of the key determined); executing the decrypted VM image.

In an embodiment of the method for protecting the virtual machine, for a migration of the virtual machine or the storage of the image of a virtual machine, the following steps are executed by the Hypervisor on the first or second computer system R:
Receiving a signal for ending the execution of a specific VM
Ending the VM execution
Creating an (unprotected) modified VM image (this is generally different to the original VM image which was loaded above since the VM was executed and has thus changed its state, e.g. modified data). As an alternative a second image is generated here which contains the runtime data and is linked to the actual VM image. This makes possible a general distribution of a VM image at a given point in time so that for a migration at runtime only the runtime data actually has to be transported.
Application of ERM protection to the (unprotected) modified VM image and creation of a modified ERM-protected VM image. To this end the modified VM image is encrypted with a key in order to obtain the ERM-protected modified VM image. The keys used above for encryption are advantageously used for this purpose. As an alternative a new key can be used, e.g. a (pseudo-) random generated key which is then transmitted to the ERM server.
Migration of the ERM-protected VM image or storage of the ERM-protected VM image.

The rights of the protected image of the virtual machine are managed on an ERM server, by an administrator for example.

The described steps can be executed iteratively and/or in another sequence.

The proposed solution enables the execution of a virtual machine to be flexibly controlled at an infrastructure provider. This allows regulatory restrictions or restrictions required because of administrative specifications to be robustly enforced. This relates to the general execution of a virtual machine, the storage of the image of a virtual machine on a data memory and also the migration to another processor. The measures applied mean that the operator or the user has the opportunity of controlling and influencing the execution environment of the virtual machine.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-7. (canceled)

8. A method for protecting a virtual machine using a control entity, comprising:
creating, by the control entity, a copy of the virtual machine;
encrypting, by the control entity, the copy of the virtual machine with a secret key, to produce an encrypted virtual machine;
providing, by the control entity, rights information comprising the private key and a usage authorization;
assigning, by the control entity, the rights information to the encrypted virtual machine; and
storing the encrypted virtual machine and the rights information so that the encrypted virtual machine and the rights information can be retrieved and the virtual machine can be decrypted and operated in accordance with the usage authorization.

9. The method as claimed in claim 8, wherein the rights information comprises a usage restriction, a reference to an access authorization of a computer system, and/or a time stamp.

10. The method as claimed in claim 9, wherein the rights information is stored on and provided by a server.

11. The method as claimed in claim 8, wherein the rights information is stored on and provided by a server.

12. A method for operating a virtual machine in accordance with rights information, comprising:
requesting, by a control entity, rights information assigned to the virtual machine;
determining, by the control entity, a usage authorization for operating the virtual machine from the rights information;
determining, by the control entity, a key for operating the virtual machine according to the usage authorization, the key being determined from the rights information;
decrypting, by the control entity, the virtual machine with the key; and
operating the virtual machine, after decryption, within a scope of the usage authorization.

13. The method as claimed in claim 12, wherein a usage policy for the virtual machine is expressed by the rights information.

14. The method as claimed in claim 13, wherein the virtual machine is configured, operated and/or executed according to the usage policy.

15. A device to operate a virtual machine, comprising a control device to execute:
requesting rights information assigned to the virtual machine;
determining a usage authorization for operating the virtual machine from the rights information;
determining a key for operating the virtual machine according to the usage authorization, the key being determined from the rights information;
decrypting the virtual machine with the key; and
operating the virtual machine, after decryption, within a scope of the usage authorization.
